(19) United States
(12) Patent Application Publication
(10) Pub. No.: US 2025/0303283 A1
(43) Pub. Date: Oct. 2, 2025

(54) INFORMATION PROCESSING APPARATUS, INFORMATION PROCESSING SYSTEM, INFORMATION PROCESSING APPARATUS CONTROL METHOD, AND PROGRAM

(71) Applicant: Sony Interactive Entertainment Inc., Tokyo (JP)

(72) Inventors: Hideki MORI, Tokyo (JP); Masaomi NISHIDATE, Tokyo (JP); Hiroya MATSUGAMI, Tokyo (JP)

(73) Assignee: Sony Interactive Entertainment Inc., Tokyo (JP)

(21) Appl. No.: 19/104,397

(22) PCT Filed: Aug. 25, 2022
(86) PCT No.: PCT/JP2022/032118

§ 371 Date: Feb. 18, 2025

(51) Int. Cl. A63F 13/48; A63F 13/25

(52) U.S. Cl. CPC A63F 13/48; A63F 13/25

(57) ABSTRACT

Disclosed is an information processing apparatus connected to a display apparatus that captures images of one or more user candidates around the display apparatus and sets a selected one of the imaged user candidates as a user. The information processing apparatus includes a processor, acquires the images of the user candidates, which are captured by the display apparatus, transmits the acquired images to an additional information processing apparatus, accepts, from the additional information processing apparatus, information identifying one user candidate selected from the user candidates imaged by the display apparatus, and controls the display apparatus to set the user candidate identified by the accepted information as the user.

### TECHNICAL FIELD

The present invention relates to an information processing apparatus, an information processing system, an information processing apparatus control method, and a program.

### BACKGROUND ART

For example, television sets and liquid-crystal displays have been conventionally used as home video game consoles and other display apparatuses. In recent years, however, a virtual reality (VR) display apparatus using a head-mounted display (HMD), a stereoscopic display capable of displaying stereoscopic images visible to the user's unaided eye, and various other display apparatuses have begun to be used.

Under the current circumstances in such a stereoscopic display described above, even if there are a plurality of persons around the above-described stereoscopic display, one of the persons is regarded as a user, and a function of the stereoscopic display itself is selected to display stereoscopic images to the one person regarded as the user.

### SUMMARY

### Technical Problem

In a case where a player of a first game console connected to the above-described stereoscopic display and a player of a second game console connected, for example, to a VR display apparatus engage in cooperative play, the stereoscopic display itself will select one of the plurality of persons as the player even if the first game console is surrounded by a plurality of persons who are candidates for the player.

However, improved amusement may be provided under some circumstances if the player of the second game console is able to select one player who operates the first game machine.

The present invention has been made in view of the above circumstances. An object of the present invention is to provide an information processing apparatus, an information processing system, an information processing apparatus control method, and a program that are able to provide improved amusement.

### Solution to Problem

In order to solve the above-described problem in the conventional examples, according to an aspect of the present invention, there is provided an information processing apparatus that is connected to a display apparatus configured to capture images of one or more user candidates around the display apparatus and set a selected one of the imaged user candidates as a user. The information processing apparatus includes a processor, acquires the images of the user candidates, which are captured by the display apparatus, transmits the acquired images to an additional information processing apparatus, accepts, from the additional information processing apparatus, information identifying one user candidate selected from the user candidates imaged by the display apparatus, and controls the display apparatus to set the user candidate identified by the accepted information as the user.

### Advantageous Effect of Invention

The present invention makes it possible to provide improved amusement.

### BRIEF DESCRIPTION OF DRAWINGS

FIG. 1 is a block diagram illustrating an example of the configuration of an information processing system according to an embodiment of the present invention.

FIG. 2 is a functional block diagram illustrating an example of the configuration of a stereoscopic display that is connected to an information processing apparatus according to the embodiment of the present invention.

FIG. 3 is a functional block diagram illustrating an example of the information processing apparatus according to the embodiment of the present invention.

FIG. 4 is a functional block diagram illustrating another example of the information processing apparatus according to the embodiment of the present invention.

FIG. 5 is a flowchart illustrating an example of the operation performed by the information processing system according to the embodiment of the present invention.

### DESCRIPTION OF EMBODIMENT

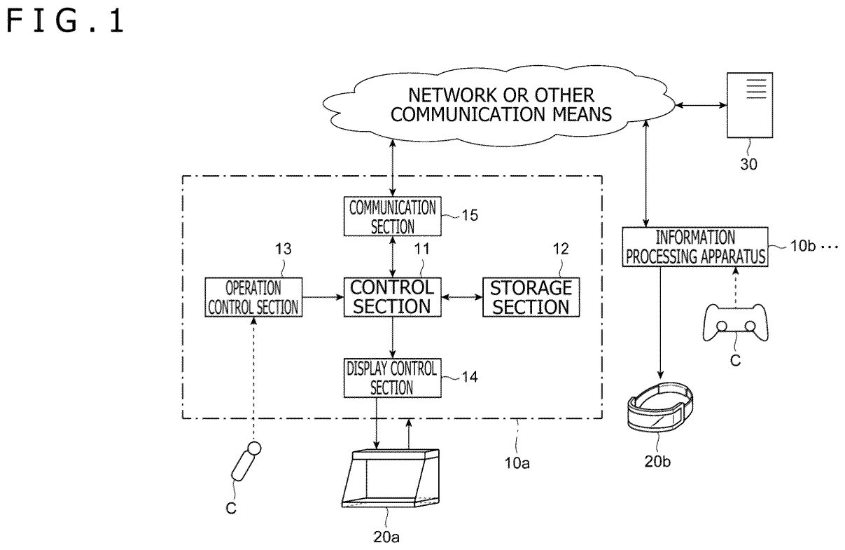

An embodiment of the present invention will now be described with reference to the accompanying drawings. As illustrated in FIG. 1, an information processing system 1 according to the present embodiment includes a plurality of information processing apparatuses 10a, 10b, . . . and display apparatuses 20a, 20b, . . . , which are connected to the information processing apparatuses 10a, 10b, . . . , respectively. A combination of such an information processing apparatus and a corresponding display apparatus corresponds to an information processing unit. Further, the individual information processing apparatuses 10 (hereinafter, when these apparatuses are not distinguished from each other, they will be simply referred to as, for example, the information processing apparatuses 10 without suffixes a, b, and so on) are communicatively connected to each other through a network. Furthermore, the information processing apparatuses 10 may be communicatively connected to a server apparatus 30 through the network.

Here, it is assumed that at least one of the display apparatuses 20a, 20b, . . . connected to the plurality of information processing apparatuses 10a, 10b, . . . is a stereoscopic display and that at least one of the other information processing apparatuses 10a, 10b, . . . is a display apparatus of a different type from the stereoscopic display (e.g., a VR display apparatus using an HMD). It should be noted that the information processing apparatuses 10 are all described below as being home video game consoles. However, the information processing apparatuses 10 according to the present embodiment are not limited to the home video game consoles, and may be, for example, general personal computers.

In the example below, it is assumed that the display apparatus 20a connected to the information processing apparatus 10a is a stereoscopic display. The display apparatus 20a allows the user to view a stereoscopic image with the naked eye. However, even if there are a plurality of user candidates around the information processing apparatus 10a (within the range where the screen of the display apparatus 20a can be visually recognized), the display apparatus 20a displays a stereoscopic image to only one of the user candidates. Additionally, the following description assumes that the information processing apparatus 10a is surrounded by a plurality of user candidates having different controllers C.

In the present embodiment, the display apparatus 20a operates either in a first mode or in a second mode. In the first mode, the display apparatus 20a itself selects a user who is able to visually recognize the stereoscopic image. In the second mode, such a user is selected in accordance with the instructions from the information processing apparatus 10a. Additionally, in order, for example, to launch an application program in the information processing apparatus 10a, it is assumed here that, prior to the second mode, there is the first mode in which the display apparatus 20a determines the user for controlling the information processing apparatus 10a. However, in a case where, for example, a general display apparatus is connected to the information processing apparatus 10a in addition to the display apparatus 20a and able to control, for example, the launch of an application program, the first mode is not necessarily required.

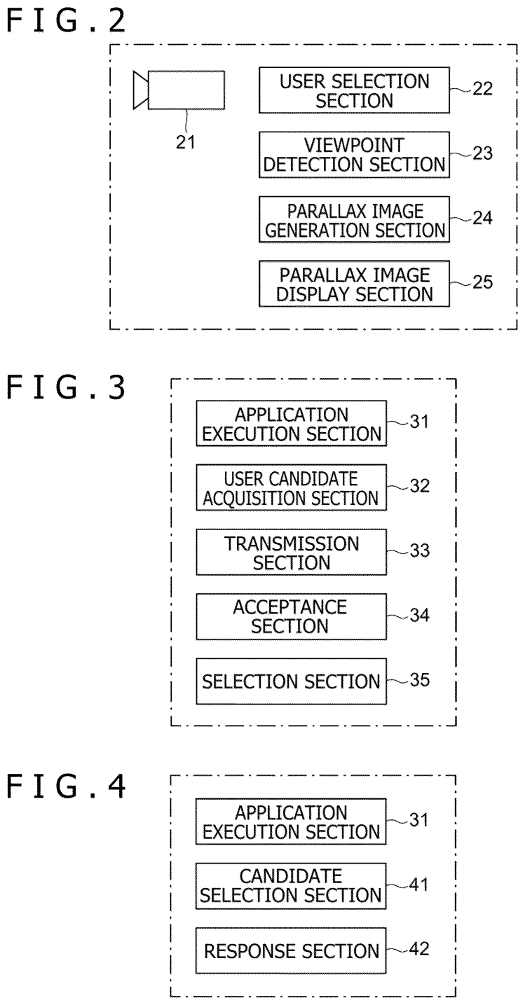

As illustrated in FIG. 2, the display apparatus 20a includes a camera 21, a user selection section 22, a viewpoint detection section 23, a parallax image generation section 24, and a parallax image display section 25.

The camera 21 included in the display apparatus 20a repeatedly captures images of an area in front of the display apparatus 20a (the range in which the parallax image display section 25 is visible), and outputs the captured images to the user selection section 22 and the viewpoint detection section 23.

The user selection section 22 recognizes the facial portions of persons in the images inputted from the camera 21. This processing can be performed using a widely known process and thus will not be described in detail here. The user selection section 22 regards, as user candidates, the persons whose facial portions are imaged and recognized, and selects one of the user candidates as the user under predetermined conditions.

In the first mode, the user selection section 22 selects, on condition of being, for example, closest to the image center, one of the user candidates whose facial portions are depicted in the images inputted from the camera 21 and recognized.

Meanwhile, in the second mode, the user selection section 22 outputs the images captured by the camera 21 (including information regarding the recognized facial portions of the persons) to the information processing apparatus 10a, and upon receiving an instruction for selecting one of the user candidates depicted in the captured images from the information processing apparatus 10a, selects the user candidate designated in the instruction as the user. That is, the user selection section 22 selects the user on condition of being designated by the information processing apparatus 10.

After the user is once selected in either the first mode or the second mode, when an image is inputted from the camera 21, the user selection section 22 tracks the facial portion of the user selected from the inputted image, and outputs information indicating the range of the facial portion to the viewpoint detection section 23.

Upon receiving the images captured by and inputted from the camera 21 and receiving the information indicating the range of the facial portion of the user from the user selection section 22, the viewpoint detection section 23 recognizes an eye position (the eye position of the selected user) within the range indicated by the inputted information from the inputted image, and outputs information regarding the recognized and acquired user's eye position to the parallax image generation section 24.

The parallax image generation section 24 generates image data to be displayed on the parallax image display section 25 in such a manner that an image for the left eye and an image for the right eye are visually recognized, respectively, at the positions of the user's left and right eyes inputted from the viewpoint detection section 23.

The parallax image display section 25 includes a display device and a lenticular lens. The lenticular lens is superimposed on the display device. The parallax image display section 25 outputs the image data generated by the parallax image generation section 24 so as to display the generated image data on the display device. As a result, the image for the left eye and the image for the right eye are visually recognized, respectively, at the positions of the user's left and right eyes detected by the viewpoint detection section 23. The above-mentioned operations performed to display parallax images on a stereoscopic display are widely known and thus will not be described in further detail.

Additionally, in the example below, it is assumed that the display apparatus 20b connected to the information processing apparatus 10b is a VR display apparatus. This VR display apparatus includes an HMD (head-mounted display), which is to be worn the head of the user, outputs and displays the image for the left eye and the image for the right eye, which are inputted from the information processing apparatus 10b, in such a manner as to present such images in front of the corresponding eyes of the user.

It should be noted that the above-mentioned display apparatus 20b is merely an example. Various other displays may be used as the display apparatuses 20 other than stereoscopic displays.

Further, as illustrated in FIG. 1, the information processing apparatuses 10 each include a control section 11, a storage section 12, an operation control section 13, a display control section 14, and a communication section 15.

The above-mentioned control section 11 is a central processing unit (CPU) or other program control device, and configured to operate in accordance with a program stored in the storage section 12. In an example of the embodiment of the present invention, the operation performed by the control section 11 varies with the type of the display apparatus 20. Specifically, the control section 11 of the information processing apparatus 10a connected to the display apparatus 20a functioning as a stereoscopic display not only performs a process of executing an application program, but also performs a system program process of acquiring the images captured by the display apparatus 20a from the connected display apparatus 20a and transmitting the acquired images (hereinafter referred to as the selection images) to the other information processing apparatuses 10b, 10c, . . . . The selection images include the images of one or more user candidates in the vicinity. Further, since the images acquired from the display apparatus 20a include information representing the facial portions of the persons recognized by the display apparatus 20a, the information processing apparatus 10a may combine the acquired images, for example, with a rectangular figure surrounding a part including the facial portion, and transmit, as the selection images, to the other information processing apparatuses 10b, 10c, . . . .

Furthermore, the information processing apparatus 10a accepts, from the other information processing apparatuses 10b, 10c, . . . , information identifying one user candidate selected from the user candidates depicted in the transmitted selection images. Subsequently, the information processing apparatus 10a controls the display apparatus 20a to set the user candidate identified by the accepted information as the user.

Meanwhile, the control section 11 of the information processing apparatuses 10b, 10c, . . . , which are communicatively connected to the information processing apparatus 10a having the above-described control section 11a and connected, respectively, to the display apparatuses 20b, 20c, . . . different from a stereoscopic display, not only performs a process of executing an application program, but also performs a system program process in a manner described below.

The above-mentioned control section 11 acquires a selection image depicting one or more user candidates from the information processing apparatus 10a, and displays the acquired selection image. The control section 11 accepts, from the users of the information processing apparatuses 10b, 10c, . . . , the selection of one of the user candidates depicted in the above displayed selection image. Subsequently, the control section 11 transmits information identifying the selected user candidate to the information processing apparatus 10a. These operations of the control section 11 will be described later.

Fundamentally, the storage section 12, operation control section 13, display control section 14, and communication section 15 of the information processing apparatus 10a connected to the display apparatus 20a, which functions as a stereoscopic display, have roughly the same configuration as those of the information processing apparatuses 10b, 10c, . . . , which do not function as a stereoscopic display. Therefore, such component elements will be described without distinction.

The storage section 12 is, for example, a memory device or a disk device, and configured to store a program to be executed by the control section 11. The program may be supplied on a computer-readable, non-transitory recording medium and copied to the storage section 12. Further, the storage section 12 functions as a work memory for the control section 11.

The operation control section 13 accepts instructions from the user, and outputs information describing the received instructions to the control section 11. Specifically, the operation control section 13 is communicatively connected to the controller device C operated by the user and configured to accept an instruction representing an operation performed, for the controller device C, by the user. Subsequently, the operation control section 13 outputs the information indicating the instruction content to the control section 11.

The display control section 14 is, for example, a display controller and configured to instruct the display apparatus 20 connected to the information processing apparatus 10 itself to display an image in accordance with the instruction inputted from the control section 11. For example, in a case where the display apparatus 20 connected to the information processing apparatus 10 itself functions as a VR display apparatus, the display control section 14 generates the image for the left eye and the image for the right eye in accordance with the instruction inputted from the control section 11, and outputs the generated images to the display apparatus 20. Meanwhile, in a case where the display apparatus 20 connected to the information processing apparatus 10 itself functions as a stereoscopic display for stereoscopic viewing, the display control section 14 generates information in a format predetermined for each display apparatus 20 for the purpose of displaying images for stereoscopic viewing, in accordance with the instruction inputted from the control section 11, and outputs the generated information to the display apparatus 20.

The communication section 15 is, for example, a network interface and configured to transmit information to the other information processing apparatuses 10 and the server apparatus 30 through the network in accordance with the instruction inputted from the control section 11. Further, the communication section 15 receives information from the other information processing apparatuses 10 and the server apparatus 30 through the network, and outputs the received information to the control section 11.

The operations of the control section 11 in the information processing apparatuses 10a, 10b, . . . according to the present embodiment will now be described in detail. In the following example, it is assumed that, upon receiving a query about the type of the display apparatus 20 connected to the information processing apparatus 10, the control section 11 included in any information processing apparatus 10 gives, in response to the query, information indicating the type of the display apparatus 20 connected to the information processing apparatus 10. In this instance, the information indicating the type of the display apparatus 20 may be information indicating whether or not the display apparatus 20 is a stereoscopic display (a display requiring user selection).

### [Information Processing Apparatus Connected to Stereoscopic Display]

As illustrated in FIG. 3, the control section 11 of the information processing apparatus 10a connected to the display apparatus 20a, which functions as a stereoscopic display, functionally includes an application execution section 31, a user candidate acquisition section 32, a transmission section 33, an acceptance section 34, and a selection section 35.

The application execution section 31 performs a process of executing a user-designated application. As a specific example, it is assumed that the application to be executed is a game application to be played collaboratively by the users of a plurality of information processing apparatuses 10 connected through the network. However, it is obvious that the application executed by the application execution section 31 is not limited to the above-mentioned example.

It is assumed that the application execution section 31 in the above-mentioned example performs a process of allowing a user-controlled virtual character (virtual character) to be shared by the plurality of information processing apparatuses 10 through the server apparatus 30 and placing the virtual character in a three-dimensional virtual game space (virtual space) identified by predetermined code information, and performs a process of allowing the user to operate the virtual character placed in the virtual space and control the position and pose of the virtual character, thereby allowing the user to play a game.

The user of each information processing apparatus 10, who participates in the game in the same game space, inputs common code information to the information processing apparatus 10 so as to let the information processing apparatus 10 acquire information regarding the game space identified by the code information from the server apparatus 30 and process the game. The above-described game processing is widely known and thus will not be described in further detail. In the present example, the server apparatus 30 manages a list of information processing apparatuses 10 participating in the game in each game space identified by the code information (including, for example, their network addresses). Therefore, each information processing apparatus 10 is able to acquire, from the server apparatus 30, information required for communication with the other information processing apparatuses 10 participating in the game in the same game space.

The user candidate acquisition section 32 receives, from the display apparatus 20a, information regarding an image captured by the camera 21 included in the display apparatus 20a. The information includes information representing the facial portion of a person recognized by the display apparatus 20a. The user candidate acquisition section 32 may cause the transmission section 33 to transmit the received image as the selection image on an as-is basis or may generate the selection image by combining the received image with an image, for example, of a rectangular figure surrounding an area identified by the information representing the facial portion.

The transmission section 33 queries the other information processing apparatuses 10b, 10c, . . . (the information processing apparatuses 10 playing a game in the same game space) communicatively connected through the network about the connected display apparatus 20, receives a response to the query, and thus acquires a list of the other information processing apparatuses 10b, 10c, . . . connected to a display apparatus 20 that does not function as a stereoscopic display (requires no user selection).

The transmission section 33 transmits, to the other information processing apparatuses 10b, 10c, . . . included in the list, the selection image (which may be an image combined with a graphic image, for example, of a rectangle in the user candidate acquisition section 32) outputted from the user candidate acquisition section 32.

In the present embodiment, when a plurality of the other information processing apparatuses 10b, 10c, . . . are included in the above-mentioned acquired list, the transmission section 33 may select one of such information processing apparatuses 10 and transmit the above-mentioned selection image to the selected one information processing apparatus 10. Alternatively, the transmission section 33 may transmit the above-mentioned selection image to each of the plurality of the other information processing apparatuses 10b, 10c, . . . included in the acquired list.

In an example of the present embodiment, the user candidate acquisition section 32 and the transmission section 33 sequentially execute the above-described processing on the repeatedly captured images until the acceptance section 34 accepts the information.

The acceptance section 34 accepts information identifying one of the user candidates depicted in the transmitted selection image from the information processing apparatus 10 to which the image is transmitted by the transmission section 33. In the present embodiment, when the transmission section 33 selects one information processing apparatus 10 and transmits the selection image and the acceptance section 34 accepts the information identifying one of the user candidates from the selected one information processing apparatus 10, the acceptance section 34 outputs, to the selection section 35, the accepted information representing the user candidate (e.g., information representing the range in which the facial portion of the user candidate is imaged).

Further, when the transmission section 33 transmits the selection image to a plurality of information processing apparatuses 10, the acceptance section 34 outputs, to the selection section 35, the information for identifying one of the user candidates that is accepted within a time limit specified by predetermined time-limit rules such as the following:
(a) Until the information identifying one of the user candidates is accepted from all of the information processing apparatuses
(b) Until the information identifying one of the user candidates is accepted from any one of the information processing apparatuses
(c) Until a predetermined time has elapsed

In accordance with the information identifying one of the user candidates that is accepted by the acceptance section 34, the selection section 35 outputs, to the display apparatus 20a, an instruction for selecting one of the user candidates designated by the information.

For example, when the transmission section 33 selects one information processing apparatus 10 and transmits the selection image and the acceptance section 34 accepts the information identifying one of the user candidates from the selected one information processing apparatus 10, the selection section 35 outputs, to the display apparatus 20a, an instruction for selecting the user candidate identified by the accepted information.

Further, even in a situation where the selection image is transmitted from the transmission section 33 to the plurality of information processing apparatuses 10, if the acceptance section 34 accepts the information identifying one of the user candidates from one of the information processing apparatuses 10 until the time limit specified by the above time-limit rules (b) and (c), the selection section 35 outputs, to the display apparatus 20a, an instruction for selecting the user candidate identified by the accepted information.

Furthermore, when the transmission section 33 transmits the selection image to the plurality of information processing apparatuses 10, and the acceptance section 34 accepts the information identifying one of the user candidates from the plurality of information processing apparatuses 10 until the time limit specified by the above time-limit rules (a) and (c), the selection section 35 performs the following processing:
(p) In a case where the same user candidate is accepted from the plurality of information processing apparatuses 10, the selection section 35 outputs, to the display apparatus 20a, an instruction for selecting the user candidate.
(q) In a case where different user candidates are accepted from the plurality of information processing apparatuses 10, the selection section 35 identifies one user candidate by using a method, such as (q1) or (q2) below, and outputs, to the display apparatus 20a, an instruction for selecting the identified one user candidate.
(q1) A user candidate identified in larger numbers (majority method)
(q2) A user candidate randomly determined from among the plurality of identified user candidates (random number method)

The information processing apparatus 10a may determine, for example, in accordance with instructions from an application program executed by the application execution section 31,
whether or not to output the selection image to a plurality of information processing apparatuses 10b, 10c, . . . , and
when the selection image is outputted to the plurality of information processing apparatuses 10b, 10c, . . . , which of the time-limit rules (a) to (c) above will be used, and further, when a plurality of candidates are identified, how to narrow them down to one candidate.

Further, when the selection section 35 outputs an instruction for selecting a user candidate to the display apparatus 20a in the above-described manner, the control section 11 of the information processing apparatus 10a may cause the application execution section 31 to perform a process of driving, for example, a vibrator (feedback device) of the controller C held by the selected user candidate in order to notify the selected user candidate that he/she is selected as the user. Additionally, the application execution section 31 may perform processing in accordance with an instruction from the controller C held by the selected user.

### [Information Processing Apparatus not Connected to Stereoscopic Display]

As illustrated in FIG. 4, the control section 11 of the information processing apparatuses 10b, 10c, . . . connected to the display apparatus 20 that does not function as a stereoscopic display includes the application execution section 31, a candidate selection section 41, and a response section 42.

Here, the application execution section 31 is basically similar to that in the control section 11 of the information processing apparatus 10a, which has been already described. In this case, the application execution section 31 is shared between a plurality of information processing apparatuses 10 through the server apparatus 30, and configured to perform a process of placing a user-controlled virtual character in a three-dimensional virtual game space (virtual space) identified by a predetermined code information and a process of letting the user operate the virtual character placed in the virtual space and control the position and pose of the virtual character, thereby allowing the user to play a game.

Further, the candidate selection section 41 receives the selection image from the information processing apparatus 10a, displays the received selection image on the display apparatus 20, and prompts the user to select one of the user candidates depicted in the selection image.

When the user selects one of the user candidates depicted in the selection image displayed by the candidate selection section 41, the response section 42 transmits information identifying the selected user candidate to the information processing apparatus 10a which is a transmission source of the selection image.

Here, as already mentioned, the selection image is, for example, an image depicting a plurality of user candidates to identify the facial portions of individual user candidates. The candidate selection section 41 may prompt the user to select any one of the identified facial portions, and the response section 42 may transmit information indicating the area of the selected facial portion (e.g., coordinate information indicating the area in the selection image) to the information processing apparatus 10a as the information identifying the selected user candidate.

### Operation

The information processing system 1 according to the present embodiment has, for example, the above configuration, and operates in a manner described in the following example. It is assumed that the display apparatus 20a, which is a stereoscopic display, is connected to the information processing apparatus 10a, that a plurality of persons who are user candidates are located within the range where the screen of the display apparatus 20a is visible, and that each of the user candidates has the controller C that can be distinguished from each other by the information processing apparatus 10a. It is also assumed that the display apparatus 20b, which is a VR display apparatus, is connected to the information processing apparatus 10b.

Initially, the display apparatus 20a operates in the first mode (the mode in which the display apparatus 20a selects a user by itself), selects one of the user candidates as the user, and receives, from the user, an instruction for launching a game application and, for example, code information for identifying the game space to be accessed by the information processing apparatus 10a in accordance with an instruction from the game application. Subsequently, the information processing apparatus 10a switches the display apparatus 20b to the second mode (the mode in which the information processing apparatus 10a selects a user) in the processing of the game application.

Meanwhile, also in the information processing apparatus 10b, the user launches the game application, and receives, for example, code information for identifying the game space to be accessed by the information processing apparatus 10b in accordance with an instruction from the game application. If the code information inputted by the user in the information processing apparatus 10a is the same as the code information inputted by the user of the information processing apparatus 10b, the information processing apparatuses 10a and 10b access information regarding a common game space, so that the users of the information processing apparatuses 10a and 10b collaboratively play the same game.

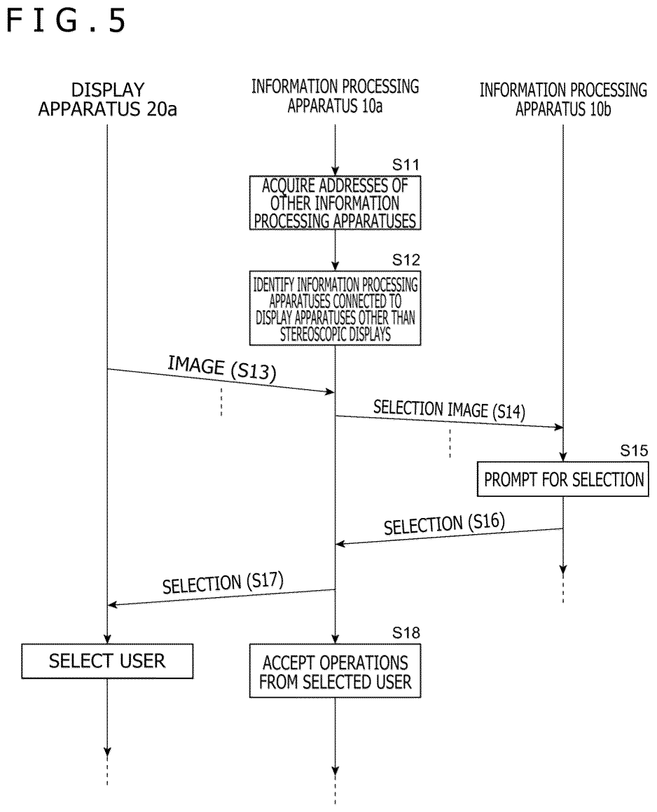

As illustrated in FIG. 5, the information processing apparatus 10a acquires, in advance, from the server apparatus 30, information (such as a network address) necessary for communicating with the other information processing apparatuses 10b, 10c, . . . participating in the game in the same game space (step S11).

Further, the information processing apparatus 10a queries the other information processing apparatuses 10b, 10c, . . . participating in the game in the same game space about the connected display apparatus 20, receives a response to the query, and thus acquires a list of the other information processing apparatuses 10b, 10c, . . . connected to the display apparatus 20 that does not function as a stereoscopic display (that requires no user selection) (step S12).

The information processing apparatus 10a receives, from the display apparatus 20a, the information regarding an image captured by the camera 21 included in the display apparatus 20a (step S13). The information includes information representing the facial portion of a person recognized by the display apparatus 20a. Therefore, the information processing apparatus 10a generates the selection image by combining the image indicated by the received information with an image, for example, of a rectangular figure surrounding an area identified by the information representing the facial portion, selects one of the information processing apparatuses 10b, 10c, . . . included in the list acquired in step S12 as a representative, and transmits the generated selection image to the selected information processing apparatus 10b, which is assumed to be the information processing apparatus 10b (step S14).

The process of selecting one of the information processing apparatuses 10b, 10c, . . . as the representative may be, for example, a process of randomly selecting one of them, or may be performed under predetermined conditions, for example, by selecting an information processing apparatus entering the game space at the earliest time if the time of entry of each apparatus can be obtained.

The information processing apparatus 10b receives the selection image from the information processing apparatus 10a, displays the received selection image on the display apparatus 20b, and prompts the user to select one of the user candidates depicted in the displayed selection image (step S15).

When the user of the information processing apparatus 10b selects one of the user candidates depicted in the displayed selection image, the information processing apparatus 10b transmits information identifying the selected user candidate to the information processing apparatus 10a, which is a transmission source of the selection image (step S16).

Upon receiving the information identifying one of the user candidates from the information processing apparatus 10b, the information processing apparatus 10a outputs, to the display apparatus 20a, an instruction for selecting the one user candidate designated by the received information (step S17).

Further, the information processing apparatus 10a outputs, for example, an instruction for driving the vibrator of the controller C held by the user candidate to be selected, thereby notifying the user candidate that he/she is selected as the user. Subsequently, the information processing apparatus 10a performs processing in accordance with an instruction from the controller C held by the selected user (step S18).

According to the above-described example of the present embodiment, in a case where a user A of the information processing apparatus 10a connected to a stereoscopic display and a user B of the information processing apparatus 10b connected to a VR display apparatus collaboratively play a game, the user B is able to select the user A, with whom the user B wants to play collaboratively, from the user candidates located near the information processing apparatus 10a.

Additionally, in a case where the users A and B play a competitive game, it is possible to play a game where, for example, the user B suddenly nominates the user A to start a battle.

### [Display on Stereoscopic Display]

The information processing apparatus 10a according to the present embodiment may further receive information regarding the position and pose of a user's hand from the controller C of a user selected from the user candidates and place a virtual hand image in a virtual space to be displayed on the display apparatus 20a by controlling the position and pose of the user's hand through the use of the information regarding the position and pose.

As an example, the controller C is attached to the user's hand. The information processing apparatus 10a detects the position of the controller C in a real space, additionally detects the user's operation on the controller C, uses information derived from such detection to determine the position and pose of a virtual hand controlled by the user, and draws the virtual hand in the game space.

If, in the above instance, the display apparatus 20a functions as a stereoscopic display, and the user moves his/her hand so as to directly touch an object displayed on the stereoscopic display, the virtual hand may overlap with the user's actual hand, making it difficult to grasp the position of the user's actual hand.

Consequently, the information processing apparatus 10a may control the position of the virtual hand placed in the virtual space in accordance with a user instruction or with the setting of a currently-executed application program.

More specifically, the information processing apparatus 10a determines the position of the virtual hand, which is based on the position of the user's hand in a real space and detected using the controller C, by moving the position of the virtual hand, by a predetermined distance, forward of the body of the user from the original position.

In the above example, the user will see the virtual hand corresponding to the user's hand at the predetermined distance rearward from the user's own hand, and the information processing apparatus 10a operates on the assumption that the virtual hand is at such a rearward position. This enables the user to operate an object in the virtual space by using the virtual hand. As a result, improved operability is achieved depending on the conditions.

### REFERENCE SIGNS LIST

1: Information processing system
10: Information processing apparatus
11: Control section
12: Storage section
13: Operation control section
14: Display control section
15: Communication section
20: Display apparatus
21: Camera
22: User selection section
23: Viewpoint detection section
24: Parallax image generation section
25: Parallax image display section
30: Server apparatus
31: Application execution section
32: User candidate acquisition section
33: Transmission section
34: Acceptance section
35: Selection section
41: Candidate selection section
42: Response section

1. An information processing apparatus that is connected to a display apparatus configured to capture images of one or more user candidates around the display apparatus and set a selected one of the imaged user candidates as a user, the information processing apparatus comprising:
processing circuitry configured to
acquire the images of the user candidates, which are captured by the display apparatus,
transmit the acquired images to an additional information processing apparatus,
accept, from the additional information processing apparatus, information identifying one user candidate selected from the user candidates imaged by the display apparatus, and
control the display apparatus to set the user candidate identified by the accepted information as the user.

2. The information processing apparatus according to claim 1, wherein the processing circuitry is further configured to
notify the user candidate identified by the accepted information that the user candidate is set as the user.

3. The information processing apparatus according to claim 1, wherein the processing circuitry is further configured to
regard the user candidate identified by the accepted information as the user,
receive an instruction inputted from the user, and
perform a predetermined process.

4. An information processing apparatus that is communicatively connected to a first information processing apparatus connected to a display apparatus configured to capture images of one or more user candidates around the display apparatus and set a selected one of the imaged user candidates as a user, the information processing apparatus comprising:
processing circuitry configured to
acquire and display images of one or more user candidates from the first information processing apparatus,
accept the selection of one of the user candidates from the user, and
transmit information identifying the selected user candidate to the first information processing apparatus.

5. An information processing system comprising:
a first display apparatus;
a first information processing unit that includes a first information processing apparatus connected to the first display apparatus;
a second display apparatus of a different type from the first display apparatus; and
a second information processing unit that includes a second information processing apparatus connected to the second display apparatus and is communicatively connected to the first information processing apparatus, wherein
the first display apparatus captures images of one or more user candidates around the first display apparatus, and sets a selected one of the imaged user candidates as a user,
the first and second information processing apparatuses each include a processor,
the processor of the second information processing apparatus configured to
acquire the images of one or more user candidates around the first display apparatus, which are captured by the first display apparatus,
display the acquired images on the second display apparatus, and
accept the selection of one of the user candidates depicted in the displayed images from the user of the second information processing apparatus, and
transmit information identifying the selected user candidate to the first information processing apparatus, and
the first display apparatus accepts information that is transmitted from the second information processing apparatus to identify the user candidate, and sets the user candidate identified by the information as the user.

6. An information processing apparatus control method for an information processing apparatus connected to a display apparatus that captures images of one or more user candidates around the display apparatus and sets a selected one of the imaged user candidates as a user, the information processing apparatus control method comprising:
acquiring, by processing circuitry, images of the user candidates, which are captured by the display apparatus;
transmitting, by the processing circuitry, the acquired images to an additional information processing apparatus;
accepting, by the processing circuitry, information from the additional information processing apparatus identifying one user candidate selected from the user candidates imaged by the display apparatus; and
controlling, by the processing circuitry, the display apparatus to set the user candidate identified by the accepted information as the user.

7. A non-transitory computer-readable storage medium storing thereon a program for an information processing apparatus connected to a display apparatus that captures images of one or more user candidates around the display apparatus and sets a selected one of the imaged user candidates as a user which, when executed by an information processing device, causes the information processing device to perform a method, the method comprising:
acquiring images of the user candidates, which are captured by the display apparatus, and transmitting the acquired images to an additional information processing apparatus;
accepting, from the additional information processing apparatus, information identifying one user candidate selected from the user candidates imaged by the display apparatus; and
controlling the display apparatus to set the user candidate identified by the accepted information as the user.

8. The non-transitory computer-readable storage medium of claim 7, further comprising:
notifying the user candidate identified by the accepted information that the user candidate is set as the user.

9. The non-transitory computer-readable storage medium of claim 7, further comprising:
regarding the user candidate identified by the accepted information as the user;
receiving an instruction inputted from the user; and
performing a predetermined process.

10. The information processing apparatus according to claim 1, wherein the processing circuitry is further configured to
transmit the acquired images to a plurality of additional information processing apparatuses,
accept information identifying user candidates from the plurality of additional information processing apparatuses, and
determine the user candidate to be set as the user based on a majority selection among the accepted information.

11. The information processing apparatus according to claim 1, wherein the processing circuitry is further configured to
transmit the acquired images to a plurality of additional information processing apparatuses,
accept information identifying user candidates from the plurality of additional information processing apparatuses, and
determine the user candidate to be set as the user based on a random selection among the accepted information.

12. The information processing apparatus according to claim 1, wherein the processing circuitry is further configured to
add identifying markers to the acquired images to indicate facial portions of the user candidates before transmitting the acquired images to the additional information processing apparatus.

13. The information processing apparatus according to claim 1, wherein the display apparatus is a stereoscopic display and the processing circuitry is further configured to
determine a position and pose of a virtual hand image in a virtual space to be displayed on the display apparatus based on input from a controller operated by the user candidate identified by the accepted information.

14. The information processing apparatus according to claim 13, wherein the processing circuitry is further configured to
position the virtual hand image at a predetermined distance from a position corresponding to a physical hand of the user in a real space.

15. The information processing apparatus according to claim 1, wherein the processing circuitry is further configured to
upon setting the user candidate as the user, cause a vibration feedback to be provided to a controller held by the user.

16. The method according to claim 6, further comprising:
notifying the user candidate identified by the accepted information that the user candidate is set as the user.

17. The method according to claim 6, further comprising:
regarding the user candidate identified by the accepted information as the user;
receiving an instruction inputted from the user; and
performing a predetermined process.

18. The method according to claim 6, further comprising:
transmitting the acquired images to a plurality of additional information processing apparatuses;
accepting information identifying user candidates from the plurality of additional information processing apparatuses; and
determining the user candidate to be set as the user based on a selection rule applied to the accepted information.

19. The method according to claim 6, further comprising:
adding identifying markers to the acquired images to indicate facial portions of the user candidates before transmitting the acquired images to the additional information processing apparatus.

20. The non-transitory computer-readable storage medium of claim 7, further comprising:
transmitting the acquired images to a plurality of additional information processing apparatuses;
accepting information identifying user candidates from the plurality of additional information processing apparatuses; and
determining the user candidate to be set as the user based on a selection rule applied to the accepted information.
